(19) United States
(12) Patent Application Publication
(10) Pub. No.: US 2013/0231877 A1
(43) Pub. Date: Sep. 5, 2013

(54) METHOD OF FILLING LEVEL MEASUREMENT

(71) Applicant: SICK AG, Waldkirch (DE)

(72) Inventors: Thomas WEBER, Waldkirch (DE); Dennis SONNTAG, Waldkirch (DE); Stefan SCHWEIGER, Waldkirch (DE)

(73) Assignee: SICK AG, Waldkirch (DE)

(21) Appl. No.: 13/780,748

(22) Filed: Feb. 28, 2013

(30) Foreign Application Priority Data
Mar. 1, 2012 (DE) 10 2012 101 725.5

(51) Int. Cl. G01F 23/00

(52) U.S. Cl. CPC G01F 23/0061
USPC 702/55; 73/304 R

(57) ABSTRACT

A method is proposed of filling level measurement in a container having a medium and at least one interference layer arranged thereabove, wherein an electromagnetic signal is transmitted along a probe arranged in the container and a signal extent of the signal reflected in the container is recorded, a first measurement pulse corresponding to the interface to the medium and a second measurement pulse corresponding to the interference layer are identified in the signal extent and the filling level of the medium is determined from the first measurement pulse and/or the filling level of the interference layer is determined from the second measurement pulse. An expectation value A_{2E} of the amplitude A₂ of the first measurement pulse and an expectation value A_{1E} of the amplitude A₁ of the second measurement pulse are calculated and the first measurement pulse and the second measurement pulse are identified using the expectation values A_{1E}, A_{2E}.

The invention relates to a method of filling level measurement in a container having a medium and at least one interference layer arranged thereabove, in particular a foam layer, in accordance with the preamble of claim 1 and to a sensor configured for this method.

A known method for filling level measurement is based on transmitting an electromagnetic signal into the container having the filling level to be measured and to evaluate the reflected signal. One possibility is to irradiate the signal openly as is done with radar. Due to the uncontrolled wave propagation, the method of time domain reflectometry (TDR) is frequently preferred. It is based on the determination of times of flight of an electromagnetic signal to determine the interval of a discontinuity of the characteristic impedance of a line. The difference from radar is that the electromagnetic waves are not irradiated into the open, but are rather conducted along a conductor. The conductor is configured as a monoprobe or as a coaxial probe which is introduced into the tank perpendicularly or obliquely and reaches as closely as possible to be bottom to cover the full measurement region.

In a TDR measurement, a very short electrical transmission pulse is fed into the conductor and runs through it in the direction of the oppositely disposed end. If the pulse is incident on an interference site, which is equal to a change in the local characteristic impedance, a portion of the transmission energy is reflected back to the line entry. The position of the interference site can be calculated in a locally precise manner from the time of flight between the transmission of the transmission pulse and the reception of the reflection. An important example of an interference site is an interface which separates two spatial zones having different physical or chemical properties such as an interface between two media.

To be able to determine the time of reception precisely, the extent of the reception signal is sampled and supplied to a digital evaluation. In this respect, for example, local extreme points are searched for in the signal extent and their time position is associated with a reflection at an interface.

Difficulties arise when a plurality of interfaces are present such as is the case, for example, with a plurality of media in a container. In this respect, it can, for example, be water which collects at the bottom of an oil tank. An important case is foam formation at the surface of a liquid. It is frequently desirable here to determine the filling level of the actual medium. A reflection at the interface to the foam can, however, be confused with the measurement pulse of the medium or can even merge with this measurement pulse in a manner such that a sensible measurement result is no longer delivered at all. A conventional evaluation algorithm which is only designed for the recognition of individual reflection signals can therefore not deal with such measurement situations.

Even an extension of a conventional evaluation algorithm by a multiecho resolution by a plurality of boundary layers is thus precluded by the requirement often not present in practice that the separation layers have to have a specific spacing so that the pulses in the echo signal which result from the separation layers have a sufficient spacing from one another. It becomes even more difficult when the individual layers of the media are not even homogeneous per se. The density and thus the relative dielectric constant can, for example, increase in accordance with an unknown, usually monotonous function with foam so that numerous mutually superimposed pulses result in the echo signal.

A possible solution could be to increase the bandwidth of the transmitted pulse. Echo pulses are thereby rather separated which arise by boundary layers disposed close to one another. At the same time, however, the demands on the electronic design also increase, for instance the scanning rate and the subsequent signal detection. In addition, at very high frequencies above 10 GHz, the damping in a monoprobe increases greatly due to the skin effect so that the signal-to-noise ratio can be insufficient. In any case, an increase in bandwidth does not yet solve the problem of distinguishing the echoes arising at the foam and medium and so of ensuring that it is not the foam level which is output as the filling level of the medium or that a falsified filling level is output.

Another solution could comprise using a coaxial probe instead of a monoprobe. The resistance to foam can thereby be improved since the echoes are mainly caused by variations in the field space within the coaxial tube. It is possible to minimize the penetration of foam into the tube by an advantageous configuration of the coaxial tube with only small openings. However, the use options are thus also restricted with respect to a monoprobe since portions of the medium to be measured can be deposited in the coaxial tube. This can impair the availability of the sensor. A use is often not possible at all in applications with hygiene demands.

The approach of reducing the foam formation from the start by the addition of chemical agents or by the operation of the plant with optimized process parameters cannot be implemented in most applications. Chemical agents influence the process medium and are anyway usually inconceivable in the food sector. The problem can be alleviated by optimized process parameters; particularly in the operating phase on start-up, a foam formation can, however, rarely be sufficiently suppressed in this manner.

An approach previously not pursued in the prior art comprises installing the probe of a customary TDR filling level sensor into the container from below. The spacing between the process connector and the medium surface is thus determined and a separation layer above the medium surface to be determined has no influence on the determination of the distance of the medium surface. This is therefore a very simple alternative possibility to solve the measurement problem in a medium with interference layers arranged thereabove. However, the filling level of the foam can thus also not itself be determined. The knowledge of the reactive dielectric constant of the medium is also necessary because the measurement pulse propagates up to the boundary layer in the medium to be measured instead of as usual in air and thus with a corresponding delay. Finally, the installation from below is not necessarily desired because it can bring about construction disadvantages, leak-tightness problems and a poor accessibility of the sensor.

EP 2 365 302 A1 describes a process in which the spacing from an interface and the relative dielectric constant of the medium producing the interface is determined a first time with reference to a transition pulse at the transition of the probe into the container and of the echo at the interface and a second time with reference to an artifact pulse from the end of the probe. If these measurements are not consistent with one another, the presence of a further boundary layer is concluded and the process is applied iteratively to the further boundary layer until all filling levels are measured. This requires precise information of the two reference pulses, that is of the transition pulse from the start of the probe and of the artifact pulse from the end of the probe. To achieve a sufficient precision here, high demands are made on the electronics which result in corresponding manufacturing costs. Not even with this can a conclusion be drawn sufficiently precisely on the transmitted portion of the transmission energy from the transition pulse of a monoprobe which, unlike a coaxial probe, is exposed to a very high number of interference effects. In addition, the artifact pulse at the end of the probe is delayed and attenuated in an initially completely undefined manner by the propagation in the different media and is therefore not available as a reliable reference in many measurement situations. In addition, at low filling levels, the artifact pulse can also have measurement pulses superimposed so that the reference is even falsified.

DE 100 51 151 A1 shows a TDR process for determining the positions of upper and lower interfaces of a first liquid which floats on a second fluid of a container. It is, however, not exactly explained how the corresponding echoes at the two interfaces are recognized and distinguished. In addition, the evaluation here is also based on the artifact pulse which is called the reference return pulse in DE 100 51 151 A1. It has the substantial disadvantages described above.

A filling level sensor is known from U.S. Pat. No. 6,724,197 B2 with which the filling level of the lower of two media layered over one another can be determined. A special and complex and/or expensive probe form is, however, required for this purpose.

U.S. Pat. No. 5,723,979 A discloses a TDR filling level sensor for measurement in liquid mixtures. Only a probe shape is described. An evaluation process, let alone a determination of the distance from a plurality of border layers, is not described.

Twin pulses at double interfaces are split by a TDR sensor using the gradient behavior of the signal shape in U.S. Pat. No. 6,445,192 B 1. It is, however, not explained how the filling level of a medium disposed below an interference layer is thus measured.

A second reflection signal is evaluated in a U-shaped twin sensor in EP 2 154 495 A2. This second reflection signal has its origin, however, not from a second interface, but rather arises on the return path of the signal along the U shape at the lower side of the same, only interface.

It is therefore the object of the invention to improve the filling level in a container having a plurality of layers. These layers may also be inhomogeneous per se, as may be the case with foam.

This object is satisfied by a method of filling level measurement in a container having a medium and at least one interference layer arranged thereabove, in particular a foam layer, in accordance with claim 1 as well as by a sensor configured for this method in accordance with claim 10. In this respect, the invention starts from the basic idea of transmitting an electromagnetic signal, in particular a microwave pulse, along a probe into the container as in time domain reflectometry, to record the signal extent of the signal reflected in the container and to identify measurement pulses in this signal extent. These measurement pulses are classified to associate them with the medium or with an interference layer. For this purpose, an expectation value is calculated for the amplitude of the first measurement pulse from the medium and for the amplitude of the second measurement pulse from the interference layer. The classification can take place by comparison with these expectation values, for example by threshold evaluation.

The method defined in claim 1 describes the case that at least one interference layer is actually present. Particularly with foam as the interference layer, the extent to which foam has formed is not necessarily known from the start. The case is therefore anticipated, preferably in advance, as a further part of the method not covered in the claim that only the medium is located in the container, for example because no foam has formed or because the foam has already collapsed. The criterion for this case is a very high first measurement pulse since the relative dielectric constant of the medium is considerably higher than that of foam. In a further special case, which is preferably additionally anticipated, only foam, that is only the interference layer, is located in the container. This can be recognized by the fact that the measurement produces an empty container because the only significant measurement pulse is the artifact pulse from the probe end. At the same time, however, the filling level measured with reference to the artifact pulse corresponds to a level below the container bottom due to the wave propagation in the foam delayed with respect to an empty container.

The invention has the advantage that the desired filling levels are also reliably measured on the absence of an interference layer. The medium surface or the interference layer is thus always directly detected in a container in which an interference layer, and in particular foam, is also located in addition to the medium. The invention is furthermore additionally able to determine the relative permittivity or the relative dielectric constant of one or more separation layers, even when parasitic effects occur and or the tank geometry causes losses by incorrect adaptation. The method works on the use of a monoprobe which, unlike a coaxial probe, is exposed to substantially more influences dependent inter alia on the container geometry. The measurement dynamics and the response time of the system are not noticeably restricted and a hardware modification of the sensor is not necessary as a rule.

The expectation values are preferably calculated from a known relative dielectric constant ∈ᵣ of the medium or from an at least assumed relative dielectric constant ∈ᵣₘᵢₙ of the interference layer and/or from a reference amplitude A_{end} of an artifact pulse arising at the probe end with an empty container. This substantially simplifies the calculation. Without making use of the artifact pulse, it would be necessary to predefine information on the tank geometry by parameterization of the sensor since very different containers and tanks are in use. Corresponding setting steps signify additional effort and/or cost and error sources for the process of putting into operation. This relates to a monoprobe to a substantially greater degree than to a coaxial probe which itself largely determines the propagation behavior by its outer conductor. Numerous factors dependent on the container and on the instrument and thus the associated setting steps and calculations can be dispensed with by referencing the expectation values to the artifact pulses. It is not the artifact pulse at the end of each signal extent of a measurement which varies constantly with the measurement conditions and which can frequently not be exactly detected sufficiently enough which is meant here, but rather that artifact pulse which is independent of dynamic measurement conditions and which would arise with identical equipment and transmission pulse in the empty container.

The expectation value A_{2E} for the amplitude A₂ of the first measurement pulse is preferably determined using the calculation rule

$${A}_{2 E} = ( \frac{{A}_{end}^{2} - {A}_{1}^{2}}{{A}_{end}} ) \cdot ( \frac{{A}_{end} - {A}_{1} - \sqrt{{ɛ}_{r}} ( {A}_{end} + {A}_{1} )}{{A}_{end} - {A}_{1} + \sqrt{{ɛ}_{r}} ( {A}_{end} + {A}_{1} )} )$$

and/or the expectation value A_{1E} for the amplitude A₁ of the second measurement pulse using the calculation rule

$${A}_{1 E} = {A}_{end} \frac{1 - \sqrt{{ɛ}_{r min}}}{1 + \sqrt{{ɛ}_{r min}}} .$$

These calculation rules provide simple, closed expressions for the expectation values. In this respect, reference should be made to a terminology and selection of the indices which appear confusing at first glance. For the first measurement pulse corresponds with A₂, the second measurement pulse with A₁. This is due to the fact that the measurement pulse arising at the medium is in by far the most cases the measured value of greater interest and should therefore be called the first measurement pulse. At the same time, this first measurement pulse only arises further to the rear from a purely technical measurement aspect so that a deviating indexing is more advantageous for the calculations.

The relative dielectric constant ∈ᵣ of the medium, the at least assumed relative dielectric constant ∈ᵣₘᵢₙ of the interference layer and/or the reference amplitude A_{end} is/are preferably predefined, calculated or determined in a calibration measurement. The relative dielectric constant ∈ᵣ of the medium can already be fixed beforehand because it is known which medium should be measured. Alternatively, a calibration measurement is carried out at a known filling level or a rough initial value is predefined, for instance a value of 80 for water, and if then a situation is recognized in the further operation in which no interference layer is present, this initial value is tracked. The at least assumed relative dielectric constant ∈ᵣₘᵢₙ of the interference layer should primarily be significantly higher than that of air, that is, for example, in the range from 1 to 10, or it amounts to a fraction of that of the medium, for example, 1%-30% thereof. Something more precise than a lower limit is neither possible nor necessary since the consistency of the foam is initially unknown; but the value also only serves to distinguish the second measurement pulse from the noise. The artifact pulse serves to compensate dependencies on the container geometry and on the signal distortion by the instrument. For this purpose, the reference amplitude can be calculated with knowledge of the container geometry and of the instrument or can be determined by simulation or can alternatively be determined in a calibration measurement. A calibration with an empty container is anyway often carried out for other reasons so that no noticeable additional effort arises.

The mean propagation speed C̅₁ of the electromagnetic signal in the interference layer from the reference amplitude A_{end} and of the amplitude A₁ of the second measurement pulse is preferably determined as

$${\overline{c}}_{1} = {c}_{0} ( \frac{{A}_{end} + {A}_{1}}{{A}_{end} - {A}_{1}} )$$

and the filling level of the medium is corrected by the time of flight signal in the interference layer delayed accordingly by C̅₁ with respect to the speed of light in vacuum C₀. A distortion of the times of flight and thus of the measured filling levels by the interference layer is thus reliably compensated.

To treat superimposed pulses, an amplitude A₁, A₂ is preferably first associated with the maximum value of the signal extent in a time window and a value of the signal extent earlier by half a pulse width is checked for a significant deviation from zero and, if this is the case, this earlier value is assumed as an additional amplitude value A₁ of a superimposed pulse and, if this is not the case, the maximum value is treated as the only amplitude A₁, A₂ of the pulse. A separation of superimposed pulses with thin interference layers is thereby possible with a very simple, but surprisingly reliable method.

The amplitudes A₁, A₂ are preferably rescaled with reference to an amplitude characteristic dependent on the filling level. The non-rescaled amplitudes are namely distorted both in the near range of higher filling levels and in the further measurement zone. One reason is superposition effects which are not caused by the occurrence of a plurality of separation layers, for example in the proximity of the probe start or of the probe end. Multiple reflections are thus formed in the near zone which merge with the first reflection and so increase the amplitude. In a similar manner, the artifact pulse at the probe end can be superimposed with a measurement pulse at a low filling level. In addition, signal losses, for example due to the skin effect, can occur further down at the probe which can likewise be compensated by an amplitude characteristic.

A transition reference amplitude of a transition pulse is preferably stored at the probe start and the influence of a vapor phase in the upper region of the container is recognized and/or compensated by comparison of a transition amplitude of the signal extent with the transition reference amplitude. Such a vapor phase is basically like a further interference layer and thus reduces the propagation speed. The corresponding distortion of the time of flight and thus of the filling levels can be compensated since the influence of the vapor phase and in particular its effective relative dielectric constant was estimated.

If a further measurement pulse arises by formation of a film at the probe, the influence of the film formation can preferably be recognized and/or compensated in that the film is treated as an apparent interference layer. The measurement thus remains reliable and precise despite a film formation or at least a corresponding maintenance message is output.

The invention will also be explained in the following with respect to further advantages and features with reference to the enclosed drawing using embodiments. The Figures of the drawing show in:

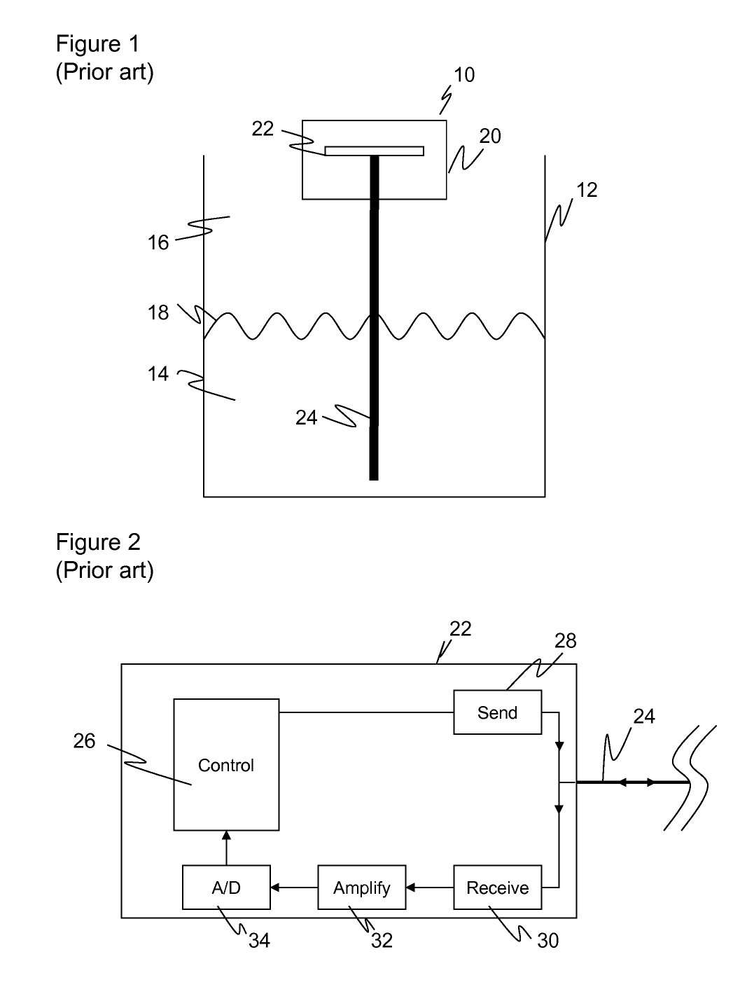

FIG. 1 a schematic cross-sectional representation of a filling level sensor in accordance with the prior art in a container;

FIG. 2 a schematic block diagram of a sensor head of the filling level sensor in accordance with FIG. 1;

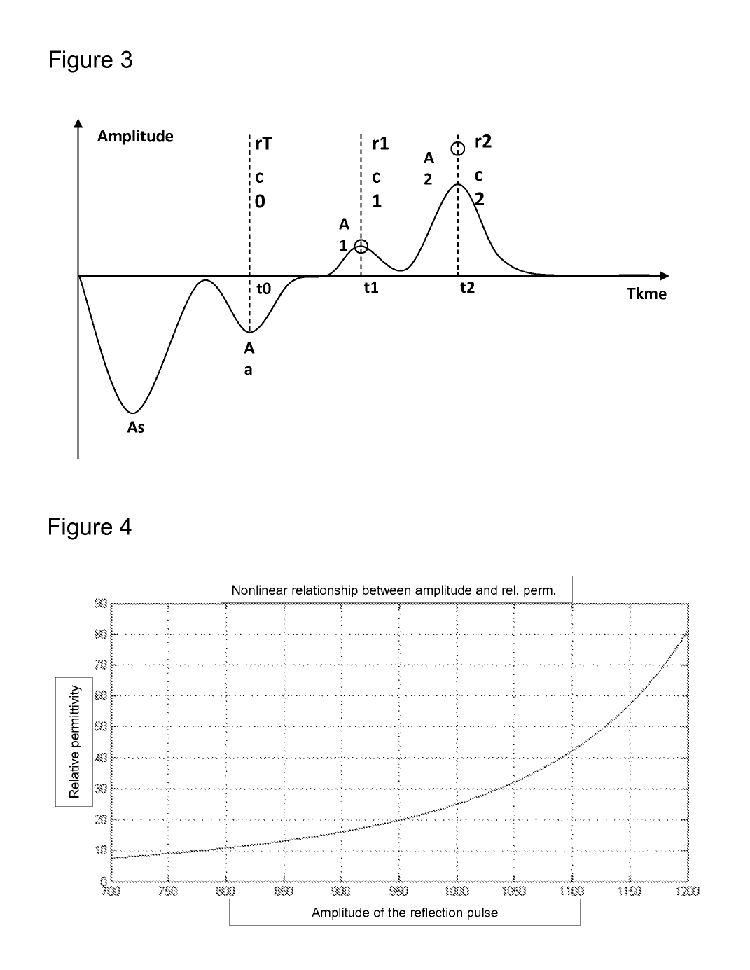

FIG. 3 an exemplary schematic signal extent of an echo signal of a filling level measurement to illustrate various variables;

FIG. 4 an exemplary representation of the relative permittivity in dependence on the amplitude of the reflection pulse:

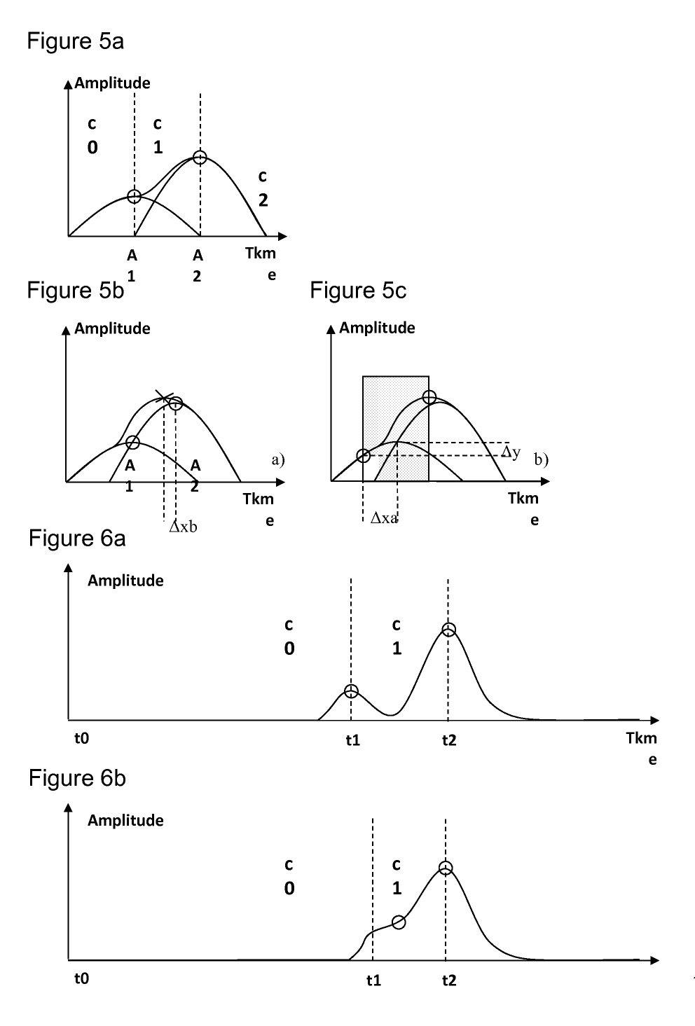

FIG. 5a an exemplary signal extent in the region of a merged pulse;

FIG. 5b a representation in accordance with FIG. 5a to explain a maximum shift;

FIG. 5c a representation in accordance with FIG. 5a to explain a range in which the merging with a further pulse can be recognized;

FIG. 6a an exemplary signal extent with two easily separable measurement pulses;

FIG. 6b an exemplary signal extent with two mutually superimposed measurement pulses;

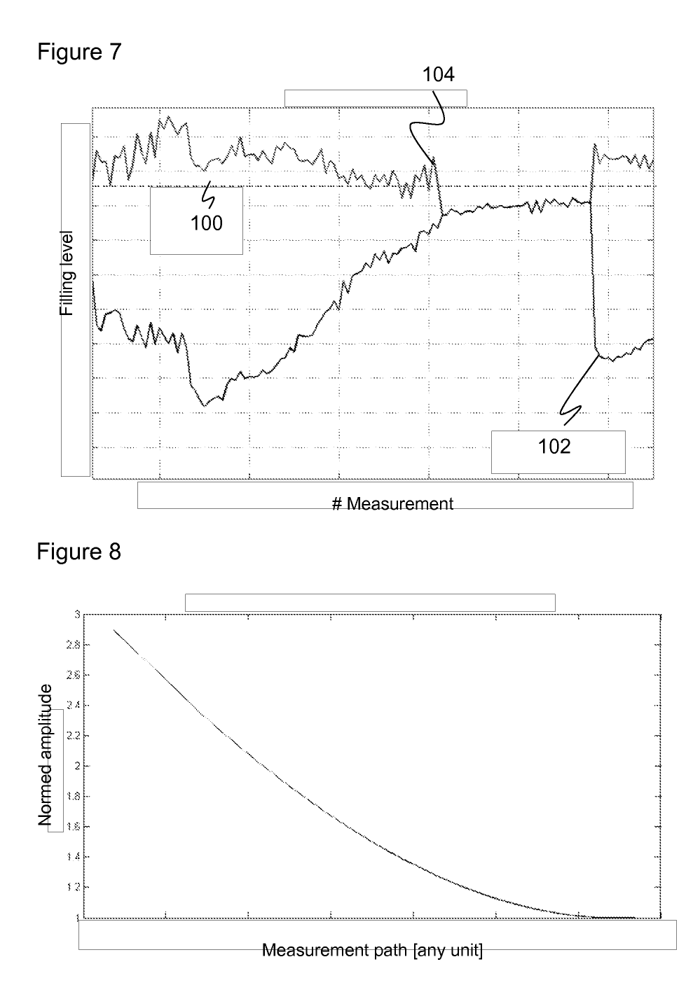

FIG. 7 a comparative representation of a plurality of specific filling level values in accordance with the invention with respect to the actual filling level and a conventional filling level measurement; and

FIG. 8 an exemplary amplitude characteristic for compensating non-linearities in the range of high filling levels.

FIG. 1 schematically shows a TDR sensor 10 in accordance with the prior art which is attached as a filling level sensor in a tank or container 12 having a medium or a liquid 14. The liquid 14 forms an interface 18 with respect to the air 16. The sensor 10 is configured to determine the distance of the interface 18 and to derive therefrom from its known attachment position the filling level and, as required, also the quantity of the liquid 14 with reference to the geometry of the container 12. Although the configuration of the sensor 10 as a filling level sensor for liquids is a very important field of use, the sensor 10 can in principle also be used for other media. In this respect, in particular bulk goods or granulates can be thought of.

The sensor 10 has a sensor head 20 having a control 22 which is preferably accommodated on a common circuit board. Alternatively, a plurality of circuit boards or flexprint carriers connected via plugs are conceivable. A probe 24 is connected to the control 22 and is here configured as an open monoprobe and thus inter alia has the advantage that it can easily be cleaned for applications in the hygiene sector.

The control 22 or its circuit board provided in the sensor head 20 is shown in a block diagram in FIG. 2. The actual control and evaluation unit 26 is implemented on a digital module, for example a microprocessor, ASIC, FPGA or a similar digital logical module as well as a combination of a plurality of such modules. As also already described in the introduction, in a measurement, a pulse is output via a microwave transmitter 28 to the probe 24 and the time of flight of the reflection pulse arising at the interface 18 and received in a microwave receiver 30 is measured to determine the distance of the interface 18 and thus the filling level in the container 12. The reception signal of the microwave receiver 30 is digitized for the evaluation after amplification in an amplifier 32 with a digital/analog converter 34.

In practice, differing from the simple situation of FIG. 1 with only one boundary layer 18 of a medium 14, cases occur in which at least two layers are present in the container 12. In this respect, a lower layer is the medium 14; but one or more interference layers are located above it, for example of foam of different consistencies. The relative permittivity or relative dielectric constant ∈ᵣ in the interference layer corresponds neither to air nor to the medium 14. As a rule, pulses of the largest amplitude or steepest flank are considered as the first measurement pulse which most likely corresponds to the desired separation layer formed by the medium 14. Provision is now made in accordance with the invention to associate the pulses with the corresponding separation layers and to output the position of the separation layer to be measured. In this respect, real interference, for example EMC influences, are not recognized as a separation layer and the interference or foam layer is also correctly identified and evaluated separately when there is actually no medium 14 in the container 12. This will be explained in more detail in the following with reference to FIGS. 3 to 7.

To be able to distinguish a measurement pulse from the medium 14 and the possible further measurement pulses from interference layers, a corresponding expectation value is determined. FIG. 3 shows for illustration a signal extent which arises when a transmission pulse is coupled to a monoprobe or to a coaxial probe with poor adaptation and is reflected by two separation layers. Here:
Aₛ: transmission pulse form the electronics
Aₐ: reflection due to the impedance jump on the transition into the container 12
A₁: reflection at the first separation layer (interference layer)
A₂: reflection at the second separation layer (medium 14)
r_{T}: reflection coefficient transition electronics—container 12
r₁: reflection coefficient transition air—interference layer
r₂: reflection coefficient transition interference layer—medium 14

If the reflections of the separation layers are not identified, an estimate of the amplitudes can take place. For this purpose, the amplitudes Aᵢ in this case relate to the voltage maxima which are determined by any desired methods.

All reflection pulses have an amplitude normed by the reflection coefficient r which can be determined, on the one hand, by the ratio of the returning wave packet having the amplitude Uᵣ to the forward running wave packet having the amplitude U_{H} and, on the other hand, by a modification of the complex wave impedance Zᵢ in the respective medium.

$$\underline{r} = \frac{{\underline{U}}_{r}}{{\underline{U}}_{h}} = \frac{{\underline{Z}}_{i + 1} - {\underline{Z}}_{i}}{{\underline{Z}}_{i + 1} + {\underline{Z}}_{i}} \qquad ( 1 )$$

The wave impedance within a coaxial conductor is described as follows in line theory:

$${Z}_{M} = \frac{{Z}_{w 0}}{2 π \sqrt{{ɛ}_{r}}} ln ( \frac{D}{d} ) \qquad ( 2 )$$

The propagation of a guided microwave in a metal container 12 can be considered as described in (2) if the variables are fixed as follows:

Z_{M}: wave impedance in the cylinder capacitor/metal tank
Z_{w0}: free field wave impedance
D: outer diameter of the container 12
d: diameter of the probe 24.

It follows from (1) and (2) (real by (2)):

$${r}_{i} = \frac{{U}_{r}}{{U}_{h}} = \frac{\sqrt{{ɛ}_{ri}} - \sqrt{{ɛ}_{ri + 1}}}{\sqrt{{ɛ}_{ri}} + \sqrt{{ɛ}_{ri + 1}}} = \frac{{c}_{i + 1} - {c}_{i}}{{c}_{i + 1} + {c}_{i}} \qquad ( 3 )$$

The amplitude shown in FIG. 3 are now determined as follows:

Aₐ=Aₛr_{T} (4)

A₁=Aₛ(1+r_{T})r₁(1−r_{T}) (5)

A₂=Aₛ(1+r_{T})(1+r₁)r₂(1−r₁)(1−r_{T}) (6)

It applies that the scaling of the amplitudes is determined by the transmission factor

dᵢ^{out}=(1+rᵢ) (7)

for the portion coming from the direction of the electronics and by

dᵢⁱⁿ=(1−rᵢ) (8)

for the portion running back into the electronics.

The amplitudes can now be evaluated with knowledge of the relative permittivity of the medium to be measured.

In order now to be independent of the geometry of the container 12 and of other signal losses, a reference amplitude A_{end} of the artifact pulse from the end of the probe 24 is now included. This reference amplitude A_{end} is calculated, simulated or determined, for example, by a calibration measurement, also repeated, in the empty state of the container 12.

A_{end}=Aₛ(1+r_{T})(1−r_{T}) (9)

applies to the reference amplitude A_{end}: A_{end} can thus be used instead of Aₛ and r_{T}.

The nth pulse can thus be determined using:

$${A}_{n} = ( {A}_{end} {r}_{n} ) \cdot {\prod }_{i = 1}^{n} ( 1 - {r}_{i - 1}^{2} ) ; {r}_{0} = 0 \qquad ( 10 )$$

An identification is possible with reference to the expected level of each pulse. If it should be clarified whether only the medium to be measured with ∈ᵣ₁ occurs, the following expectation is placed on the first pulse (with air ∈ᵣ₀=1 above the first separation layer):

$${A}_{1} = {A}_{end} {r}_{1} = {A}_{end} \frac{1 - \sqrt{{ɛ}_{r 1}}}{1 + \sqrt{{ɛ}_{r 1}}} \qquad ( 11 )$$

If the pulse A1 determined in a measurement is considerably smaller than that calculated with the help of (11), the detected pulse is then not the expected separation layer.

It is now possible, explicitly or implicitly (depending on the number of separation layers) to evaluate the second reflection. The reflection amplitudes which enter into the expectation values for the second or subsequent separation layers have to be determined with the highest possible precision.

It follows from (11)

$$\begin{matrix}{r}_{1} = \frac{{A}_{1}}{{A}_{end}} \\ or & ( 12 ) \\ \sqrt{{ɛ}_{r 1}} = \frac{1 - {r}_{1}}{1 + {r}_{1}} = \frac{1 - \frac{{A}_{1}}{{A}_{end}}}{1 + \frac{{A}_{1}}{{A}_{end}}} = \frac{{A}_{end} - {A}_{1}}{{A}_{end} + {A}_{1}} & ( 13 ) \\ {A}_{2} = {A}_{end} ( 1 - {r}_{1}^{2} ) {r}_{2} = {A}_{end} [ 1 - {( \frac{{A}_{1}}{{A}_{end}} )}^{2} ] {r}_{2} & ( 14 )\end{matrix}$$

It follows from (13) and (3):

$${r}_{2} = \frac{\sqrt{{ɛ}_{r 1}} - \sqrt{{ɛ}_{r 2}}}{\sqrt{{ɛ}_{r 1}} + \sqrt{{ɛ}_{r 2}}} = \frac{{A}_{end} - {A}_{1} - \sqrt{{ɛ}_{r 2}} ( {A}_{end} + {A}_{1} )}{{A}_{end} - {A}_{1} + \sqrt{{ɛ}_{r 2}} ( {A}_{end} + {A}_{1} )} \qquad ( 15 )$$

The expected value for the second amplitude using (14) and (15) is thus

$$\begin{matrix}{A}_{2} = {A}_{end} [ 1 - {( \frac{{A}_{1}}{{A}_{end}} )}^{2} ] \frac{{A}_{end} - {A}_{1} - \sqrt{{ɛ}_{r 2}} ( {A}_{end} + {A}_{1} )}{{A}_{end} - {A}_{1} + \sqrt{{ɛ}_{r 2}} ( {A}_{end} + {A}_{1} )} & ( 16 a ) \\ {A}_{2} = ( \frac{{A}_{end}^{2} - {A}_{1}^{2}}{{A}_{end}} ) \cdot ( \frac{{A}_{end} - {A}_{1} - \sqrt{{ɛ}_{r 2}} ( {A}_{end} + {A}_{1} )}{{A}_{end} - {A}_{1} + \sqrt{{ɛ}_{r 2}} ( {A}_{end} + {A}_{1} )} ) & ( 16 b )\end{matrix}$$

This method can also be extended to n separation layers. The respective terms for rᵢ have to be resolved accordingly, which is not shown here for reasons of clarity. The knowledge of the amplitudes of the higher separation layers and of the relative permittivity of the separation layer searched for is necessary for this purpose.

If the relevant permittivity of the separation layer to be measured is not known, it can be determined by a calibration process. This takes place once before the actual measurement when it is ensured that only air is contained in the container 12 except for the medium 14 or also during operation when the process itself recognizes that no interference layer is currently present above the medium. Parameter changes with respect to the relative permittivity can hereby be determined. In accordance with (11), (12) and 13), the relative permittivity is then determined by:

$${ɛ}_{rMess} = {( \frac{{A}_{end} - {A}_{mess}}{{A}_{end} + {A}_{mess}} )}^{2} \qquad ( 17 )$$

Only a single reflection pulse A_{Mess} from the medium 14 occurs in this measurement arrangement. Since an initial calibration measurement does not have to consider any response time, numerous repetitions can be carried out and evaluated statistically. It must also be taken into account that the relationship between the relative permittivity and the amplitude of the reflection pulse Aₘₑₛₛ is nonlinear. This is shown by way of example in FIG. 4 for an exemplary container geometry.

If an interference layer is in the container 12, it can be assumed that reflection pulses appear electrically further remote due to the slowed propagation speed of the electromagnetic wave in this interference layer since it is no longer possible to conclude a distance from a time with the same scaling. For this reason, the measurement window should be extended, and indeed so that the measurement dynamics are not influenced, on the one hand, and no boundary layers can be overlooked, on the other hand. For this purpose, it is determined using the following relationships how much the window should be increased:

The time of flight of a wave is determined in a homogeneous medium by:

$${t}_{i} = \frac{{h}_{i}}{{c}_{0}} \sqrt{{ɛ}_{ri} {μ}_{ri}} , \qquad ( 18 )$$

where:
tᵢ: time of flight in a separation layer
hᵢ: height or thickness of a separation layer
c₀: propagation speed in a vacuum
∈ᵣᵢ: relative permittivity or dielectric constant
μᵣᵢ: relative permeability

In this description μᵣᵢ=1 is always assumed. This requirement can possibly be infringed with coated probes, film formation or two-conductor probes, in which case the corresponding relative permeability would have to be taken along. Coatings or a film formation can also have the result that the effective permittivity in the region differs from that of air because dielectric material is in the propagation space of the wave. This cannot be taken into account in advance, but a possibility is set forth further below to measure and thus compensate the effect of the film formation.

For N separation layers, a time of flight delay results of:

$$Δ t = {\sum }_{i = 1}^{N} \frac{{h}_{i}}{{c}_{0}} ( \sqrt{{ɛ}_{ri}} - \sqrt{{ɛ}_{rB}} ) \qquad ( 19 )$$

Where ∈_{rB} is the relative dielectric constant of the substance expected above the medium 14 in the container 12 without an interference layer, that is, for example, air with ∈_{rB}=1. The measurement window should be increased by this time of flight delay. If memory requirements do not play a significant role for the signal extent and for the repetition rate of the measurement values, the effect can naturally simply be overestimated and a multiple of the otherwise usual measurement window can be used.

The delayed time of flight in the interference layer, however, also has an even more central effect on the actual filling level measurement value than for the selection of the measurement window. Depending on the thickness of the interference layer, this can considerably impair the measurement precision so that a time of flight correction is recommended.

As already determined above as equation (3), the relationship between the reflection coefficient and the propagation speed is given by

$$r = \frac{{c}_{i + 1} - {c}_{i}}{{c}_{i + 1} + {c}_{i}} \qquad ( 3 )$$

If there is only one interference layer, it is simplified to

$${r}_{1} = \frac{{\overline{c}}_{1} - {c}_{0}}{{\overline{c}}_{1} + {c}_{0}} \qquad ( 21 )$$

Equation (21), however, also simultaneously applies to a plurality of homogeneous and inhomogeneous interference layers if it is assumed that these interference layers can be represented by a mean propagation speed. With equation (12)

$$\frac{{A}_{1}}{{A}_{end}} = \frac{{\overline{c}}_{1} - {c}_{0}}{{\overline{c}}_{1} + {c}_{0}} \qquad ( 22 )$$

applies and thus

$${\overline{c}}_{1} = {c}_{0} ( \frac{{A}_{end} + {A}_{1}}{{A}_{end} - {A}_{1}} ) \qquad ( 23 )$$

The calculation of the distance by means of the time of flight on the presence of an interference layer is then done using

s=c₀t₁+ c̅₁(t₂−t₁) (24)

In this respect, possible times of flight in the sensor 10 will have to be taken into account as a constant offset. If a plurality of interference layers have to be taken into account which cannot be detected by a mean propagation speed,

$${r}_{n} = \frac{{A}_{n}}{( {A}_{end} ) \cdot {\prod }_{i = 1}^{n - 1} ( 1 - {r}_{i}^{2} )} \qquad ( 26 )$$

applies due to equation (10) in the nth reflection. The propagation speed in the respective separation layer is calculated

$$\begin{matrix}{\overline{c}}_{n} = {\overline{c}}_{n - 1} \frac{1 + {r}_{n}}{1 - {r}_{n}} . & ( 27 ) \\ {\overline{c}}_{n} = {c}_{0} {\prod }_{i = 1}^{n} \frac{1 + {r}_{i}}{1 - {r}_{i}} & ( 28 )\end{matrix}$$

thus generally applies and

$$S = {\sum }_{i = 0}^{n} {\overline{c}}_{i} ( {t}_{i + 1} - {t}_{i} ) \qquad ( 29 a )$$

applies to the path traveled. A further problem with an interference layer located above the medium is that the thickness of the interference layer is not always sufficient to produce a respective separate measurement pulse at all for the interference layer and the medium 14. Provision is therefore made in an embodiment of the invention to separate superimposition pulses and also to carry out a time of flight compensation in such situations.

FIG. 5a first shows by way of example such a superimposition pulse in which the interval of the two generated pulses is still large enough to be able to identify the pulses as local maxima.

This is no longer the case in the situation of FIG. 5b. The pulse width is determined once in advance to evaluate the superimposition pulse. All the reflection pulses are always of the same width independently of the amplitude, at least with a sufficient bandwidth of the system; this width is predefined by the width of the transmission pulse. A search window which has half the width of a pulse and is shown in FIG. 5c is then defined for separating the transmission pulse. The highest value which is just no longer in the window is determined to the left of the maximum found. This determines the amplitude and the index of the reflection pulse of the higher separation layer and is used for the time of flight correction.

In this approximation, different effects occur which result in too low a filling level indication in part and too high a filling level indication in part.
The thinner a separation layer, the smaller the time of flight delay. The smaller the time of flight delay, the smaller the error due to an incorrect correction of the time of flight. The time of flight delay results in too low a filling level indication.
The amplitude of the second measurement pulse at the interference layer is underestimated by Δy, which likewise results in too low a filling level indication.
If two pulses merge, as in FIG. 5b, the reflection pulse of the second medium appears displaced to the left by Δx_{b} by the superimposition; the filling level is determined a little higher than with separate pulses due to this effect.
The time of flight correction starts earlier than necessary by Δxₐ, whereby the filling level indication is likewise increased.

Although the opposite effects are only considered from a quality aspect and a quantitative compensation by no means necessarily follows on form this, the measurements show that this compensation is surprisingly successful and that very precise filling levels can be measured overall.

Also to illustrate this, a complete example for use with a classification of measurement pulses in different possible measurement situations will now be described. Two separation layers are located in the container 12, with here the medium 14 being water, for example, and the interference layer foam. In each case, the filling level of the water is being sought, independently of whether foam has formed above it and of which layer thickness the foam then has.

Five states must then be distinguished and a respective specific associated filling level should be output:

| | | |
|---|---|---|
| 1 | Empty tank | Filling level 0 mm |
| 2 | No water, but foam | Filling level 0 mm |
| 3 | Only water | Filling level of the water |
| 4 | Water and a lot of foam | Filling level of the water |
| 5 | Water and a little foam | Filling level of the water |

The two cases 1 and 3 can already be detected by a filling level measurement in accordance with the prior art. FIGS. 6a and 6b show a typical exemplary signal extent for the two cases 4 and 5.

The following routine is used for the measurement:
I. The final reference pulse is determined several times in the empty container 12, possibly filtered or corrected in its amplitude using a characteristic and then the amplitude is stored.
II. The relative permittivity of the medium 14 is determined and stored. In this case, the value of 80 for water is known; alternatively a calibration measurement can take place in advance or in measurement operation if no foam is in the container 12.
III. A range of the relative permittivity ∈ᵣₘᵢₙ of the foam is estimated and stored. This can also be done by a calibration measurement if it is known that there is foam in the container 12. Alternatively, this value is set somewhere significantly above 1 or to a fraction of the value of the medium 14 since foam as a mixture of air and medium certainly has only a smaller relative permittivity than the pure medium 14.
IV. The expectation values for the amplitudes of the measurement pulses are calculated and thresholds derived therefrom.
   a) If the first pulse is a medium pulse, it has to have at least 90% of the amplitude

$${A}_{1} = {A}_{end} {r}_{1} = {A}_{end} \frac{1 - \sqrt{80}}{1 + \sqrt{80}}$$

for example.
   b) If it is a foam pulse in this respect, it has a smaller amplitude which has to amount to at least

$${A}_{1} = {A}_{end} {r}_{1} = {A}_{end} \frac{1 - \sqrt{{ɛ}_{r min}}}{1 + \sqrt{{ɛ}_{r min}}}$$

or to a portion thereof scaled by a predefined portion, where ∈ᵣₘᵢₙ represents the lower limit for foam.
   c) A pulse following after the foam pulse is then a medium pulse if it has at least 90% of the amplitude

$${A}_{2} = {A}_{end} [ 1 - {( \frac{{A}_{1}}{{A}_{end}} )}^{2} ] \frac{{A}_{end} - {A}_{1} - \sqrt{80} ( {A}_{end} + {A}_{1} )}{{A}_{end} - {A}_{1} + \sqrt{80} ( {A}_{end} + {A}_{1} )}$$

for example.
V. The signal extent or the echo curve is recorded.
VI. The pulses are identified using the expectation values from IV., optionally while separating superimposition pulses as described above
VII. The time of flight correction likewise described above is carried out.

Continue at step V. The cycle starts again.

The simpler case 4 with water and a lot of foam in accordance with FIG. 6a is hereby recognized without problem and the time of flight is estimated as intended. In case 5 in accordance with FIG. 6b, when only a little foam is present and the pulses are therefore merged, a certain measurement error results, with, however, as explained, different contributions to the measurement error being opposite to one another and cancelling one another out relatively well.

In order also to cover case 2, a special blank test has to be introduced. If no medium 14 is present in the container 14 and if therefore also no reflection pulse is found, the final reference pulse is sought to confirm that the probe 24 is undamaged. Since this final pulse appears further to the rear due to foam in the container 12 and can no longer be determined at all under certain conditions, it must first be polled whether there is foam in the container 12 before the final pulse check. Step V. is carried out for this purpose and is compared with condition IV b). If foam is present, the check is skipped.

FIG. 7 shows an exemplary test measurement. In the test, a thin foam layer having a thickness of approximately 3-4 cm is arranged above the surface of the water. The height of the water filling level is then output via a larger number of measurement repetitions using the method just explained.

A dashed line 100 shows the actual water filling level as a reference. The lower line 102 shows a measurement using a conventional sensor which attempts to mask the foam layer and determines the spacing from the medium surface without time of flight compensation. The measurement value is falsified downwardly due to the time of fight delay in the foam layer.

The upper line 104 shows the result of the test measurement. The measurement value fluctuates about the reference value 100 of the actual water filling level. In this respect, the measurement errors are significantly reduced with respect to the conventional measurement 102.

If the interference layer is very close to the container cover, it can happen that amplitudes appear larger than they actually are due to superimposed multiple reflections. The propagation speed is here close to the propagation speed in vacuum; multiple reflections therefore do not delay as much as those which arise between two separation layers.

The reflection at the first separation layer has, in accordance with (11), the amplitude:

A₁=Aₛ(1+r_{T})r₁(1−r_{T})=A_{end}r₁ (11)

As can be recognized at (1−r_{T}) the reflection pulse is reflected again in part when running into the electronics. The amplitude of the reflected portion amounts to:

A_{M1}=A_{end}·r₁·(−r_{T})·r₁ (32)

The reflection factor of the tank must now be determined (see (9)):

$${r}_{T} = \sqrt{\frac{{A}_{s} - {A}_{end}}{{A}_{s}}} \qquad ( 33 )$$

Generally, the amplitude of the kth multiple reflection is:

A_{Mk}=A_{end}·r₁^{k+1}(−r_{T})^{k} (34)

If now a superimposition of these multiple reflections occurs, the pulse shape also enters into the addition as a weighting.

The transmission pulse is described sectionally using a functional rule which describes the extent of the pulse in the t direction whose amplitude is, however, normed to 1. At a point t=g the amplitude should be able to be assumed to be zero. This pulse extent is designated by Γ(t) and is, for example, a piece of a parabola or a piece of a Gaussian function which should be set discontinuously to zero at g at the latest.

The amplitude of the first reflection pulse can thus adopt the following value depending on the pulse shape and on the interval from the first separation layer:

$${\hat{A}}_{1} = {A}_{end} \cdot {r}_{1} \cdot {\sum }_{k = 0}^{N} {( - {r}_{T} )}^{k} \cdot {r}_{1}^{k} \cdot Γ ( 2 \cdot k \cdot {t}_{1} ) \qquad ( 38 )$$

where k is a running variable. With (33) and (38):

$${\hat{A}}_{1} = {A}_{end} \cdot {r}_{1} \cdot {\sum }_{k = 0}^{\frac{g}{2 {t}_{1}}} {( - \sqrt{\frac{{A}_{s} - {A}_{end}}{{A}_{s}}} )}^{k} \cdot {r}_{1}^{k} \cdot Γ ( 2 \cdot k \cdot {t}_{1} ) \qquad ( 39 )$$

then applies, with

$$N = \frac{g}{2 {t}_{1}}$$

being set here. Then

$${A}_{1} = \frac{{\hat{A}}_{1}}{{\sum }_{k = 0}^{\frac{g}{2 {t}_{1}}} {( - \sqrt{\frac{{A}_{s} - {A}_{end}}{{A}_{s}}} )}^{k} \cdot {r}_{1}^{k} \cdot Γ ( 2 \cdot k \cdot {t}_{1} )} \qquad ( 38 )$$

In addition to the calculation of the superimposed amplitude and the compensation as in (38), it is also possible to compensate the superelevation by an empirically determined compensation function dependent on the system. The amplitude level should be constant at every position in the t direction on the presence of at least one separation layer and with an existing compensation of all waviness in the y direction. If the amplitude level of a first interface in a tank is now varied from completely full to completely empty or vice versa and is recorded, a measure is obtained for the growth of the amplitudes in the upper range in dependence on the position. After a corresponding smoothing and norming, an amplitude characteristic then results as shown by way of example in FIG. 8. The characteristic can selectively be stored as a look-up table or as a correction function determined by the function fit.

In addition to variations of the amplitude in the near range by multiple reflection, amplitude drops in the far range are also possible due to attenuations, for example due to a skin effect or impedance changes. This can likewise be compensated by the amplitude characteristic.

A compensation of vapor phases is provided in a further embodiment. In a vapor phase, the gaseous medium above the liquid surface is saturated so much with vapor that the propagation speed within the gas differs considerably from the speed of light. If this is not taken into account, this results in the distance from the medium surface being incorrectly determined, i.e. the medium surface is measured as too low.

The vapor phase causes an impedance change of the container 12 and thus a change to the empty state results without a vapor phase. If the empty curve was stored, the influence can be discovered by a changed reflection at the transition from the process connector into the container 12. This reflection is detected and can be evaluated in exactly the same way as a reflection of a boundary layer 18. It is a demand that the absolutely small variation of the reflection at the transition from the processor connector to the container 12 can only be evaluated when following reflections through media 14 are sufficiently remote. This is, however, as a rule the case at a distance of a few centimeters. With a smaller distance the compensation is no longer possible, which is, however, not critical since the absolute measurement error is then correspondingly small since the absolute time of flight in the vapor phase is small.

In a further embodiment, effects are compensated by a film formation on the probe 24. Such films have the result that the wave impedance along the probe 24 changes. This change can be significant in dependence on the size of the film and on the geometry of the container 12 so that reflections result by the film which are so high that they may be interpreted as a filling level pulse or at least have a great influence on the echo signal, whereby increased measurement inaccuracies can result. In addition, the electromagnetic wave which is guided along the probe 24 is delayed by the dielectric property of the film.

The echo signals on a film formation have a very large similarity with the signals which occur in the generally observed boundary layers 18. The method in accordance with the invention can thus likewise be used to improve the measurement behavior on formation of a film.

To suppress a further conceivable source of distortion of the measurement pulses, conceivable nonlinearities of the A/D converter 34 or of a mixer can also be taken into account. For this purpose, for example, a characteristic is determined which mediates between the actual voltage values and the digitized voltage values.

The transmission signal is a pulse in each case in the previously described embodiments. Alternatively, a transmission signal can be used which arises in a pulse compression process by windowing a radio frequency carrier. In this respect, in a preprocessing, an envelope of the echo curve is determined and this simplified echo curve is evaluated like the signal extent used in the above description.

Another variant of the transmission signal comprises not generating the transmission signal per se as very short, but rather using comparatively long pulses with accordingly extremely short increase times. The flank is then primarily evaluated for determining the time of flight, i.e. the time position and the amount of the jump. The amplitude of the pulses is again a measure for the change of the wave impedance or of the reactive dielectric constant so that the above processes can be used. However, individual reflection sites can simultaneously be separated more clearly and more simply by the very short increase times. With an almost continuous change of the wave impedance, individual jumps in the echo no longer result, but rather a correspondingly more or less constant echo signal.

It is in principle even conceivable not to use any pulses as a transmission signal. In an FMCW process, for instance, a plurality of optionally overlapping portions arise in the spectrum of interest of the intermediate frequency in accordance with the distance from the reflection sites. The amplitude of the portions corresponds to the intensity of the reflection and is thus a measure for the impedance jump. The method explained above can here be used on the spectrum of the intermediate frequency in an FMCW process instead of on the signal extent in the time range in order thus to measure filling levels of a medium 14 which is superimposed with at least one interference layer.

1. A method of filling level measurement in a container (12) having a medium (14) and at least one interference layer arranged thereabove, wherein an electromagnetic signal is transmitted along a probe (24) arranged in the container and a signal extent of the signal reflected in the container (12) is recorded, in that a first measurement pulse corresponding to the interface (18) to the medium (14) and a second measurement pulse corresponding to the interference layer are identified in the signal extent and the filling level of the medium (14) is determined from the first measurement pulse and/or the filling level of the interference layer is determined from the second measurement pulse,
wherein an expectation value A_{2E} of the amplitude A₂ of the first measurement pulse and an expectation value A_{1E} of the amplitude A₁ of the second measurement pulse are first calculated and the first measurement pulse and the second measurement pulse are identified using the expectation values A_{1E}, A_{2E}.

2. A method in accordance with claim 1, wherein the interference layer is a foam layer.

3. A method in accordance with claim 1,
wherein the expectation values are calculated from a known relative dielectric constant ∈ᵣ of the medium (14) or from an at least assumed relative dielectric constant ∈ᵣₘᵢₙ of the interference layer and/or from a reference amplitude A_{end} of an artifact pulse arising at the probe end with an empty container.

4. A method in accordance with claim 3,
wherein the expectation value A_{2E} for the amplitude A₂ of the first measurement pulse is determined using the calculation rule
$${A}_{2 E} = ( \frac{{A}_{end}^{2} - {A}_{1}^{2}}{{A}_{end}} ) \cdot ( \frac{{A}_{end} - {A}_{1} - \sqrt{{ɛ}_{r}} ( {A}_{end} + {A}_{1} )}{{A}_{end} - {A}_{1} + \sqrt{{ɛ}_{r}} ( {A}_{end} + {A}_{1} )} )$$
and/or the expectation value A_{1E} for the amplitude of the second measurement pulse A₁ is determined using the calculation rule
$${A}_{1 E} = {A}_{end} \frac{1 - \sqrt{{ɛ}_{r min}}}{1 + \sqrt{{ɛ}_{r min}}} .$$

5. A method in accordance with claim 3,
wherein the relative dielectric constant ∈ᵣ of the medium (14), the at least assumed relative dielectric constant ∈ᵣₘᵢₙ of the interference layer and/or the reference amplitude A_{end} is/are predefined, calculated or determined in a calibration measurement.

6. A method in accordance with claim 1,
wherein a mean propagation speed C̅₁ of the electromagnetic signal in the interference layer pulse is determined from the reference amplitude A_{end} and from the amplitude A₁ of the second measurement as
$${\overline{c}}_{1} = {c}_{0} ( \frac{{A}_{end} + {A}_{1}}{{A}_{end} - {A}_{1}} )$$
and the filling level of the medium (14) is corrected by the time of flight of signal in the interference layer delayed accordingly by C̅₁ with respect to the speed of light in vacuum C₀.

7. A method in accordance with claim 1,
wherein to treat superimposed pulses, first an amplitude A₁, A₂ is associated with the maximum value of the signal extent in a time window and a value of the signal extent earlier by half a pulse width is checked for a significant deviation from zero and, if this is the case, this earlier value is assumed as an additional amplitude value A₁ of a superimposed pulse and, if this is not the case, the maximum value is treated as the only amplitude A₁, A₂ of the pulse.

8. A method in accordance with claim 1,
wherein the amplitudes A₁, A₂ are rescaled using an amplitude characteristic dependent on the filling level.

9. A method in accordance with claim 1,
wherein a transition reference amplitude of a transition pulse is pre-stored at the probe start and the influence of a vapor phase in the upper region of the container (12) is recognized and/or compensated by comparison of a transition amplitude of the signal extent with the transition reference amplitude.

10. A method in accordance with claim 1,
wherein a further measurement pulse arises by formation of a film at the probe (24) and the influence of the film formation is recognized and/or compensated in that the film is treated as an apparent interference layer.

11. A sensor (10) having a transmitter (28) and a receiver (30) for transmitting and receiving an electromagnetic signal, as well as having a control (26) which is designed to determine the filling level of a medium (14) and/or of an interference layer in a container (12) with reference to the time of flight of the signal, wherein
the control (26) is configured to determine the filling level using a method of filling level measurement in a container (12) having a medium (14) and at least one interference layer arranged thereabove, wherein an electromagnetic signal is transmitted along a probe (24) arranged in the container and a signal extent of the signal reflected in the container (12) is recorded, in that a first measurement pulse corresponding to the interface (18) to the medium (14) and a second measurement pulse corresponding to the interference layer are identified in the signal extent and the filling level of the medium (14) is determined from the first measurement pulse and/or the filling level of the interference layer is determined from the second measurement pulse, wherein an expectation value A_{2E} of the amplitude A₂ of the first measurement pulse and an expectation value A_{1E} of the amplitude A₁ of the second measurement pulse are first calculated and the first measurement pulse and the second measurement pulse are identified using the expectation values A_{1E}, A_{2E}.

12. A sensor in accordance with claim 11, wherein the sensor is a TDR filling level sensor.

13. A sensor in accordance with claim 11, wherein the signal is a microwave signal.
